(19) United States
(12) Patent Application Publication
(10) Pub. No.: US 2015/0231668 A1
(43) Pub. Date: Aug. 20, 2015

(54) HORIZONTAL ROTARY SIEVE

(71) Applicant: GREEN METALS SOLUÇÕES AMBIENTAIS S.A., Belo Horizonte (BR)

(72) Inventors: JOÃO BOSCO DE BARROS, Belo Horizonte (BR); Dener De Siqueira, Belo Horizonte (BR); Ricardo André Fiorrotti Peixoto, Ouro Preto (BR)

(21) Appl. No.: 14/532,612

(22) Filed: Nov. 4, 2014

(30) Foreign Application Priority Data
Feb. 14, 2014 (BR) 20 2014 003470-1

(51) Int. Cl. B07B 1/22; B07B 9/00

(52) U.S. Cl. CPC B07B 1/22; B07B 9/00

(57) ABSTRACT

An entirely dry-operated rotary horizontal sieve, or for use in areas where mine tailings resulting from mining and beneficiation activities are to be recovered is described. The sieve is equipped with a system of rotating screens arranged in sequential order in accordance with the increasing size of the holes in their mesh, said screens being latched to separating rings arranged in sequential order. The sifting of particles of different sizes can then be performed in one single operation by density and gravity. Under each of the screens a specific container is available for storage and then transportation of the sieved material.

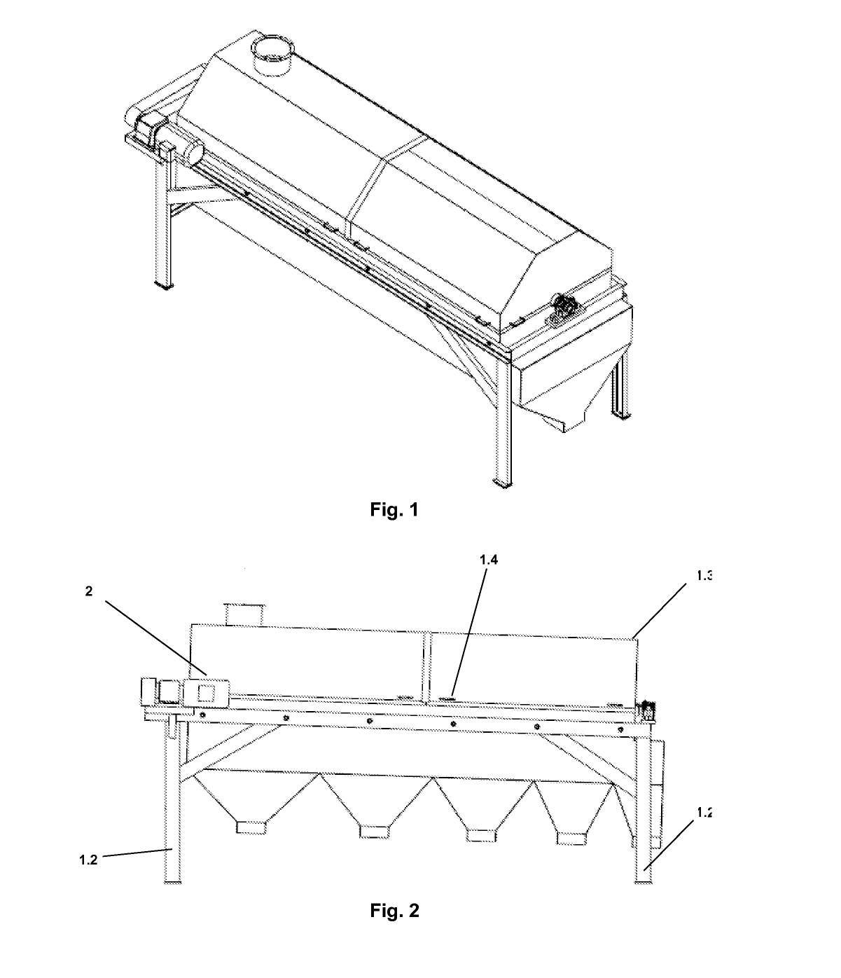

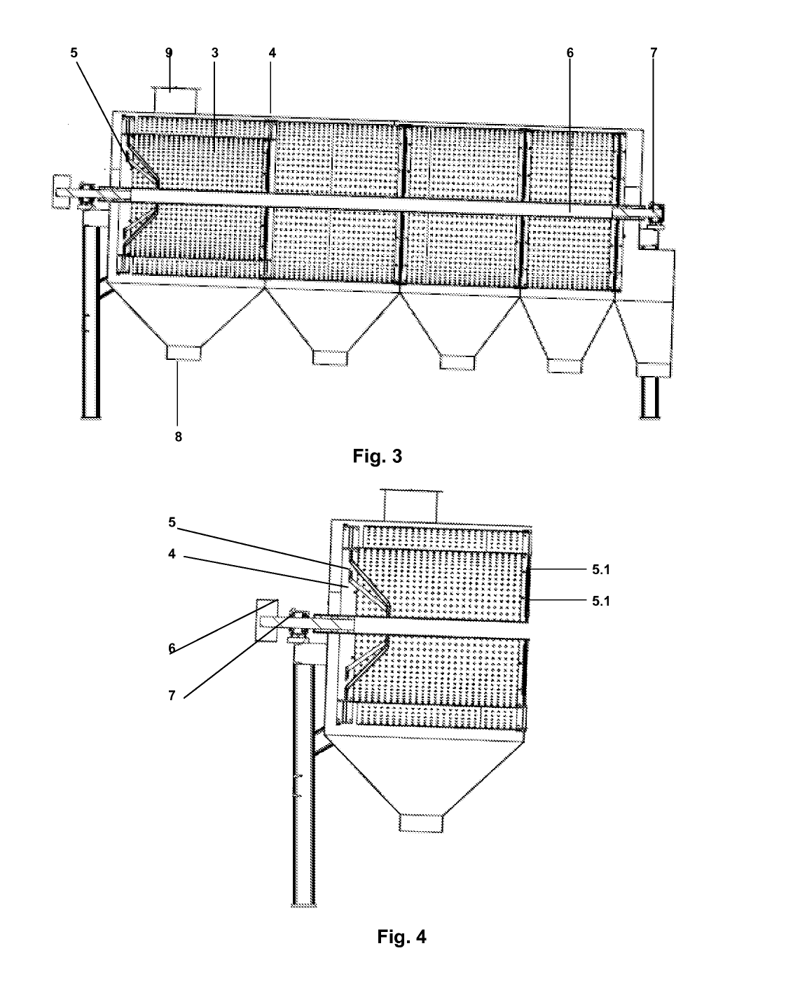

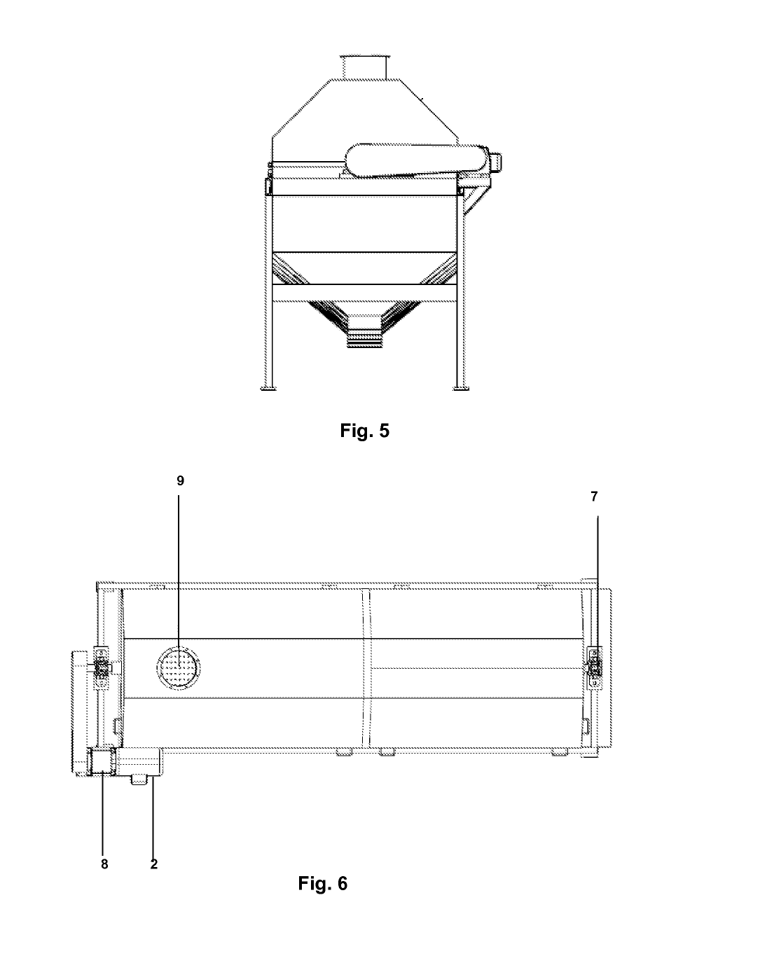

### PRIORITY CLAIM AND CROSS-REFERENCE TO RELATED APPLICATIONS

This application claims priority under 35 U.S.C. 119 to Brazilian Patent Application No. BR 20 2014 003470-1 filed on 14 Feb. 2014, the entire disclosure of which is incorporated by reference herein.

### BACKGROUND

Rotary sieves are currently available in the market although there is none to be found in the segment of tailings recovery that is entirely dry-operated.

### DESCRIPTION OF EXAMPLE EMBODIMENTS

Described in the present disclosure is a rotary sieve whose design allows it to sift ore of various grain sizes in one single operation. The disclosure refers to the dry horizontal rotary sieve to be used in areas where mine tailings resulting from ore extraction and beneficiation are to be recovered; the dry operation of the machine is based on a system of rotating sieves arranged in tiers according to the increasing size of the holes in the mesh, fastened to sequential separating rings that makes it possible to separate grains of different sizes by their density in one single operation. Each of the sieves is fitted with a specific container underneath to direct the material separated by grain sizes to specific storage silos in accordance with the predetermined grain size.

The dry sifting process with a rotating system is a solution for the unfeasibility of sieving naturally damp ore tailing.

The MU8402254-0—“Arrangement introduced into Rotary Sieve” refers to the rotary sieve comprised of a frame made of metal profiles mounted on bearings and supporting a revolving cylinder mounted on a rotating shaft located along the central axis powered by an motor-reducer unit, with holes punctured throughout its length and helical guides to induce a linear movement to the material to be sifted; said material is then dropped into a container located underneath, and finally directed to a chute outside. The sieve is also comprised of a vertical header pipe for the collection of sifting residue; the pipe is fastened to the frame, which has symmetrical holes of increasing diameter placed at the bottom of the helical guides. This rotary sieve is different from the already existing device which only processes material of the same grain size that is afterwards sent to a single header pipe, while the solution proposed herein presents differentiated screens placed in a sequential order consistent with the diameter of the holes in the mesh in order to enable the screening of ore of different particle sizes for different uses, all in one single operation.

Now, PI0318826-4—a “Rotary Cylindrical Sorting Sieve”—is comprised of a base frame, bearings, a central shaft, a crosspiece and a crosspiece supporting rotary external and internal components; a first screen with a smaller diameter and larger holes holds a larger screen with smaller holes; an external drum collects the waste; a lid; a stationary receiver, that is, a non-rotating receiver that is fastened to the base frame by rods; a front crosspiece with an exit chute for the outpouring of grains and material retained by the sieve; a drum to hold the waste; a bagging chute. It is different from the existing device in as much as it has two screens with holes of different sizes, one placed over the other, to sift similarly-sized particles. The present solution is a horizontal screening machine with a separator that has up to 5 (five) discharge chutes; it is comprised of successive round-shaped screens latched to the separators so that it can, in one single operation, sift grains of different sizes to be used for different purposes.

The MU9000300-4—a “ROTARY SIEVE FOR SEPARATION OF MINERAL IMPURITIES IN THE SUGAR AND ETHANOL INDUSTRY”—consists in a rotary sieve equipped with only an internal helical device which allows low density cereal straw to move within the equipment thereby separating, by cyclical movements, solid residues that are collected in peripheral screen placed next to the central discharge hole; the said sieve can be used to separate solid residues of sugarcane billets that were initially discarded during the dry cleaning process on the sugarcane feed rollers. It is different from the already existing device because it has one single peripheral screen, while the solution shown here is a horizontal sieve with a classifier that has up to 5 (five) discharge chutes, and is made of several sequentially placed screens latched to separators in accordance with the size of the material to be separated.

The main advantage of the present disclosure is the entirely dry-operated extraction of clay, silica and iron ore from tailings resulting from beneficiation activities in tailings dams and mine tailings deposits. The machine not using water for its operation significantly reduces the immeasurable impact to the environment created by the beneficiation process of deposits of tailings contained in decanting tanks, and tailings dams, and turns the waste into raw material for a cost-saving and cost-effective industrial production.

The horizontal rotary sieve enables speed, pressure and flow control making it possible to sort, separate and transfer the resulting material to one of the 5 (five) discharge chutes of the sieving machine. The material resulting from the sifting operation is graded by growing particle size; the ore particles are screened by density and gravity, passing from one screen to the other. The screens are separated from each other by rings. For example, in a mine tailings screening process iron ore, clay and silica particles can be graded as:
smaller than 0.3 mm (three-tenths of a millimeter);
larger than 0.3 mm and smaller than 1 mm (one millimeter);
larger than 1 mm and smaller than 2 mm (two millimeters);
larger than 2 mm and smaller than 6.3 mm (six millimeters and three-tenths of a millimeter);
larger than 6.3 mm (six millimeters and three-tenths of a millimeter).

During the sifting, with preset pressure and flow, the exhaust fan located in the upper section will collect the airborne smaller size particles which will then be sent to the cyclone battery and sleeve-type filter (not shown in the picture).This will result in extra gathering, transportation and storage of clay, silica and ore by exhaustion.

The present disclosure is detailed herein in accordance with the attached drawings.

Drawing 1 shows the sifting machine in perspective.

Drawing 2 shows the side of the sieving machine.

Drawing 3 shows a cross section of the sieving machine.

Drawing 4 shows a cross section of the first section of the sieving machine.

Drawing 5 shows a front view of the sieving machine.

Drawing 6 shows the sieving machine from above.

According to Drawings 1 to 6 the horizontal rotary sieving machine (1) is comprised of a casing (1.1) containing, as described above, five sections arranged in sequential order to collect material of increasing particle size by density and gravity resulting from the downward slope of the bearings the machine rests upon (1.2).The feeder (2) receives the material that is poured into the casing (1.1), comprised of sections formed by rotating screens with holes of (3) different diameters, said screens being aligned in sequential order by increasing hole size, set in a circle, and attached to the separators (4) by clips (5.1) placed at the end of a set of supporting rods (5) that are used to hold the screens (3). The separator rings (4) rotate about a central axis (6), driven by a motor reducer unit (7), both standing on the downward-placed bearings (1.2). The separators (4) are comprised of metal rings borne by supporting rods (5) which in turn are held and set in motion by the rotating shaft at the center (6). The screens (3) are arranged in a circle, following a sequential order determined by the size of their holes, around the separators (4) to which they are fastened by clips (5.1) set at the end of a set of supporting rods (5) (3); the separator rings (4) rotate about a central axis (6), driven by a motor reducer unit (7), both standing on the downward-placed bearings. The rotational movement of the screens together with the different heights of the bearings, (1.2) allows the finer material to be sifted in the first sections while the rest is sent by density and gravity to the next section, thereby separating materials of different particle sizes in a single operation. The material screened in each of the sections drops into containers (8)stowed under each one of the screens (3) and is taken afterwards by conveyor belt (not pictured here) to the corresponding silos (not pictured here) for storage of sifted material of the desired grain size. In the upper central section of the casing (1.1) an exhaust fan (9) takes the airborne clay and minerals to the cyclone battery (not pictured here) and a sleeve filter (not pictured here) which form the exhaust system used to collect the smaller particles; on its upper part the casing (1) has inspection openings with a lid (1.3) and a handle(1.4).

The structural detailing presented here can be used to screen other types of materials besides mine tailings. The raw material used for its manufacturing can be replaced by similar material. The machine's shape, dimensions, number of discharge chutes and size of separators can also vary.

1. (canceled)

2. A horizontal rotary sieve, comprising:
a casing configured to receive material at a first end and sloped downward from the first end to a second end;
a plurality of screens positioned within the casing and rotatable around a central axis extending from the first end of the casing to the second end of the casing, the plurality of screens arranged in sequential order from the first end of the casing to the second end of the casing to collect and sift the material by grain size,
wherein the downward slope of the casing and the rotation of the plurality of screens about the central axis allows finer particles of material to be sifted at the first end of the casing and larger particles of the material to travel towards the second end of the casing.

3. The horizontal rotary sieve of claim 1, wherein the plurality of screens are arranged with the smallest grain size at the first end of the casing and the largest grain size at the second end of the casing.

4. The horizontal rotary sieve of claim 1, which includes a plurality of separators separating the plurality of screens from each other.

5. The horizontal rotary sieve of claim 4, wherein the separators include a set of metal rings held in place by support rods.

6. The horizontal rotary sieve of claim 4, wherein the separators are separator rings that rotate about the central axis extending from the first end of the casing to the second end of the casing.

7. The horizontal rotary sieve of claim 1, which includes an exhaust fan to collect airborne particles.

8. The horizontal rotary sieve of claim 1, which includes plurality of containers positioned underneath the casing, each of the plurality of containers positioned to receive material from a respective screen of the plurality of screens.

9. The horizontal rotary sieve of claim 1, which includes a conveyor belt positioned underneath the casing.
